(19) United States
(12) Patent Application Publication
(10) Pub. No.: US 2012/0235944 A1
(43) Pub. Date: Sep. 20, 2012

(54) TOUCHSCREEN ENTRY OF CONSTRUCTION PUNCH LIST ITEMS DIRECTLY ON A PLAN

(76) Inventor: Robert L. McIntosh, Pacific Grove, CA (US)

(21) Appl. No.: 13/482,798

(22) Filed: May 29, 2012

Related U.S. Application Data
(62) Division of application No. 12/434,162, filed on May 1, 2009.
(60) Provisional application No. 61/049,659, filed on May 1, 2008.

(51) Int. Cl. G06F 3/041

(52) U.S. Cl. 345/173

(57) ABSTRACT

A method for establishing a construction punch list system for managing and inspecting a construction project is disclosed. Plan data, of a construction project, is provided from a database in a central server to sub-contractors having field operable graphical touchscreen devices. A touchscreen device is used to display a selected plan. Using the touchscreen device, color-coded or shape-coated construction deficiency data, in relation to the selected plan, is entered in graphical and textual form. The construction deficiency data is communicated to the central server. From the construction deficiency data, a construction punch list is generated in graphical or tabular form. The construction deficiency data from the server is distributed to at least one sub-contractor, indicating needed fixes. The needed fixes are fixed, then the construction deficiency data is updated to reflect fixes. The updated construction deficiency data is accessed for inspecting and supervising the construction project.

### CROSS-REFERENCE TO RELATED APPLICATION

This application is a divisional of pending U.S. patent application Ser. No. 12/434,162, filed May 1, 2009, which claims priority from provisional application Ser. No. 61/049,659, filed May 1, 2008.

### TECHNICAL FIELD

The present invention relates generally to tracking task completion within the construction industry and associated trades, and more particularly, to a system and method of electronically preparing and maintaining punch lists for the completion of building projects.

### BACKGROUND

In the U.S. construction industry, contractual agreements are written to allow an owner of a building to withhold final payment from a general contractor until a construction project is satisfactorily completed. The contractor is thus contractually bound to complete a punch list of uncompleted or improperly completed construction items. A punch list is a checklist of all construction deficiencies such as items that are incomplete, improperly completed, neglected, or require replacement or fixing. Punch lists have long been used on commercial projects and are frequently being used in residential construction as well. The punch list is thus, generally, a list of tasks or to-do items used to organize completion of a construction project.

For homes built on speculation (i.e., “spec homes”), a construction superintendant generally creates a punch list near the end of a project. For a contracted home, the owner or the owner's agent (e.g., a designer such as a licensed architect or professional engineer) creates the punch list. The contractor uses the list to make his or her own inspection. The contractor then signs the list thus creating a binding contract to fix all items on the list. In order to make an accurate punch list, the person performing the inspection (i.e., the “inspector” of the project) must be familiar with the plans and specifications of the project.

Once a construction project is substantially complete (i.e., the project is at a point where all sub-contractors believe they have completed to their respective tasks), the owner or owner's agent verifies that all contractual work has complied with the design or specifications by performing a walk-through of the project. The punch list is developed consisting of uncompleted or unsatisfactory work items (i.e., reasonable construction deficiencies such as flaws).

Once punch list items are agreed upon, the general contractor directs the appropriate sub-contractor to make necessary adjustments or repairs. Once all of the list items are properly addressed, the creator of the punch list checks that all items have been satisfactorily completed. Final contractor payment is generally made when each item on the punch list is addressed to meet the project design required by the owner's contract. Examples of punch list items include damaged building components, incomplete or improperly installed components, or problems with the final installation of building materials.

One type of existing punch list contains a number of columns including an item list, a punch or new list, a sub-contractor list, and a date of inspection list. The punch list can take many different forms. Frequently, the punch list is a hand-written document where the inspector simply fills in each of the appropriate columns during the inspection and assigns a sequential number to each deficiency item. Typically and additionally, a paper copy of the associated floor plan is marked at the location of the deficiency with the corresponding number of each deficiency item.

After the item list is completed identifying each construction deficiency, brightly-colored self-adhesive paper dots are typically placed on or near each item to be repaired, replaced, or modified in some way. The sub-contractor responsible for each deficiency, identified from the sub-contractor list, is given a separately compiled list showing only items for a particular sub-contractor and a photocopy of the marked up floor plan. Once the sub-contractor has corrected the deficiency, the inspector will re-inspect and, if the deficiency is properly corrected, sign-off each item in an approval column.

However, each generation of the list (e.g., original list production, sorting out separate lists for each of the sub-contractors, recompiling lists with non-conforming items, etc.) is time-consuming and laborious. Additionally, the item list may contain cryptic descriptions of problems or the hand-written notes are difficult to decipher. Therefore, what is needed is a simple way to enter all construction deficiencies, sort by contractor, provide for non-ambiguous descriptions and efficiently distribute deficiency information to the various parties for correction.

### SUMMARY

In an embodiment, a method for establishing a construction punch list system for managing and inspecting a construction project of the type having a set of plans, a contractor, sub-contractors and at least one inspector is disclosed. The method comprises providing plan data of a construction project from a database in a central server. The plan data is provided to subcontractors having field operable graphical touchscreen devices.

Using a touchscreen device, a selected plan is displayed. Using the touchscreen device, color-coded or shape-coded construction deficiency is entered. The color-coded or shape-coded construction deficiency data is in relation to the selected plan. The construction deficiency data is entered in graphical and textual form.

The construction deficiency data is communicated to the central server. A construction punch list is generated. The construction punch list is generated from the construction deficiency data. The construction punch list is in graphical or tabular form.

Construction deficiency data is distributed to at least one subcontractor. The construction deficiency data is from the server. The construction deficiency data indicates needed fixes.

The needed fixes are fixed. After the needed fixes are fixed, the construction deficiency data is updated to reflect fixes. The updated construction deficiency data is accessed, for inspecting and supervising the construction project.

A graphical representation of a construction plan, from the plan data, may be displayed on a touchscreen device. Using the touchscreen device, a construction deficiency symbol may be positioned on the graphical representation of the construction plan. The color-coded or shape-coded deficiency data may establish the color or shape of the construction deficiency symbol.

In another embodiment, a construction punch list system is disclosed. The system comprises a server containing a database of contractor plans for a construction project. The server further contains construction deficiency data related to the database of contractor plans.

Display devices are configured to graphically display contractor plans from the database. The plans are graphically displayed on an interactive touchscreen.

There is a means for entering construction deficiency data on the graphically displayed plan. The means for entering construction deficiency data includes a graphical identifier unique to a category of punch items. The means for entering construction deficiency data uses the touchscreen.

A network links the plurality of display devices to the server.

There is a means for distributing construction deficiency data. The construction deficiency data is distributed to selected users of display devices.

There is a means for updating the construction deficiency data. The server and the plurality of display devices are cooperatively configured to indicate a construction punch list of punch items. The server and the plurality of display devices are further cooperatively configured to indicate corresponding fixes. The construction punch list of punch items and corresponding fixes are in graphical or tabular form. The construction punch list of punch items and corresponding fixes is from the updated construction deficiency data.

The means for entering construction deficiency data with a graphical identifier may be a construction deficiency symbol. The construction deficiency symbol may be positionable on the graphically displayed plan by using the touchscreen. There may be a menu of construction deficiency data choices.

In another embodiment, a method of generating and using a construction punch list for inspecting and managing a construction project is disclosed. The method comprises displaying a selected plan on a portable touchscreen device. The selected plan is from a database of construction plans in a networked server.

Using the portable touchscreen device, construction deficiency symbols are positioned. The construction deficiency symbols are positioned on at least one displayed selected plan. Each construction deficiency symbol indicates a construction deficiency at a corresponding location on the construction site.

On the portable touchscreen device, construction deficiency data is entered. The construction deficiency data is associated with each construction deficiency symbol.

At the networked server, the construction deficiency data is updated.

A construction punch list is generated from the construction deficiency data. The construction punch list is distributed.

When a construction deficiency has been remedied, construction deficiency data is entered indicating a punch list item is completed.

Updating the construction deficiency data at the networked server may comprise updating the construction deficiency data at the server via manual entry. Updating the construction deficiency data at the server via manual entry may be from a portable touchscreen device, in an on-line mode.

A local version of the construction deficiency data in the portable touchscreen device may be updated when the portable touchscreen device is in a stand-alone mode. The construction deficiency data at the networked server and the local version of the construction deficiency data in the portable touchscreen device may be updated by data comparison. The updating by data comparison may be done when synchronizing.

### BRIEF DESCRIPTION OF THE DRAWINGS

The appended drawings illustrate exemplary embodiments of the present invention and must not be considered as limiting its scope.

FIG. 1 is an exemplary screen shot in accordance with various embodiments of the present invention that shows a floor plan of a condominium unit to be inspected.

FIG. 2 is an exemplary screen shot describing how the floor plan of FIG. 1 may be uploaded and defined.

FIG. 3 is an exemplary pull-down menu in accordance with various embodiments of the present invention.

FIG. 4 is an exemplary graphical floor plan report created for a specific sub-contractor.

FIG. 5 is an exemplary tabular listing of all open punch list items present for an entire unit.

FIG. 6 is a construction punch list system diagram.

FIG. 7 is a construction plan displayed on a touchscreen device.

FIG. 8 is a flow diagram for establishing and using a construction punch list system.

### DETAILED DESCRIPTION

“Punch on the Plan” is a name for a method and system for touchscreen entry of construction punch list items directly on a plan view. An embodiment may be seen at http://www.punchlist.net/index.cfm. While existing punch list systems manage punch lists on a handheld computer, the method and system disclosed herein displays a view of a construction plan on a touchscreen device, for direct placing of construction deficiency symbols on the displayed plan. Construction deficiency data associated with each construction deficiency symbol is entered on the touchscreen device. A centralized server and the touchscreen devices cooperate to update the construction deficiency data and generate construction punch lists.

A system and method for establishing, managing and using a construction punch list are herein described. Construction plans, including floorplans, electrical and plans and plumbing plans are available, and construction is under way at a construction site. Construction deficiencies are being noted by various personnel associated with the construction project, using the system and method.

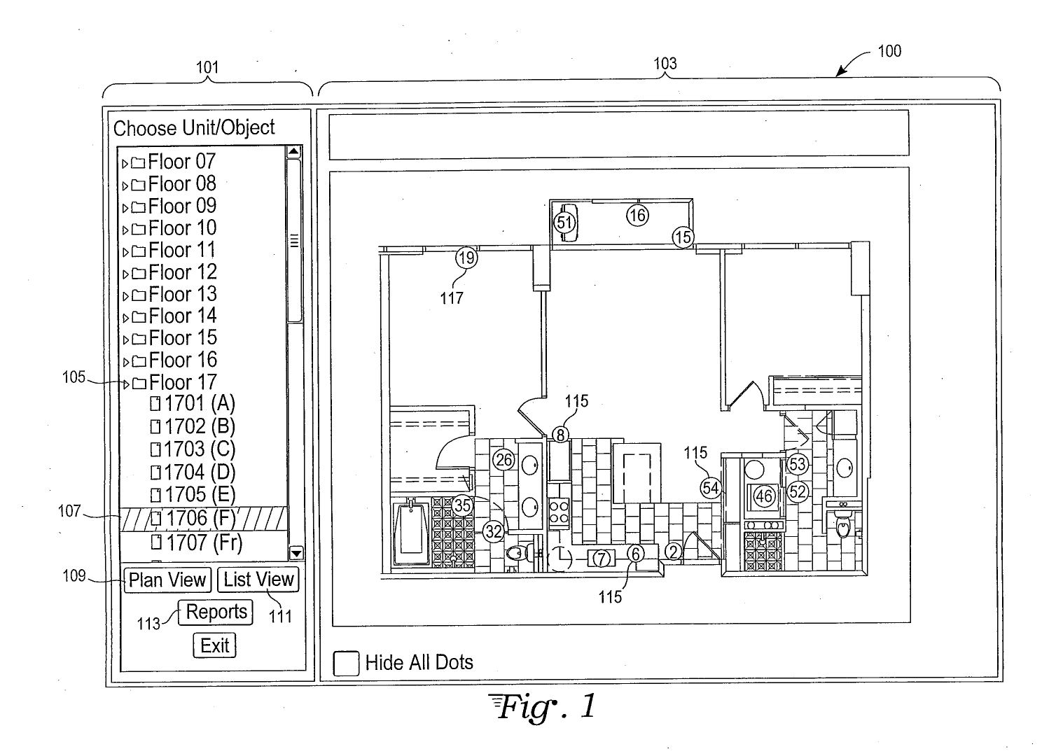

With reference to FIG. 1, an exemplary screen shot 100 of a floor plan of a condominium unit may be displayed, using the method and system, on a laptop computer (i.e., a notebook computer), a tablet-type personal computer (i.e., a tablet PC), a personal data assistant, or any number of electronic devices capable of storing and retrieving electronic data. Although the exemplary screen shot 100 depicts a layout of a condominium, a person of skill in the art will recognize that the present invention described herein may be used on any type of construction: industrial, residential, and commercial.

Various types of data entry systems can be used depending upon the type of electronic device employed. For example, a laptop computer user may enter data with a keyboard and a mouse. A tablet PC user may enter data exclusively via pull-down menus on a touch-screen. Also, hybrid systems employing both a touch-sensitive screen and a mouse/keyboard or stylus system may be used. In many applications where a person is performing a walk-through and developing a punch list, a tablet PC or other device with a touch-sensitive screen may be desirable to simplify operations described herein. For brevity of notation, the term “inspector” shall be used in the following descriptions to identify anyone preparing a punch list.

Two main sections of the exemplary screen shot 100 include an object list 101 and a graphical display area 103. The object list 101 is arranged for a particular project type and may include building addresses, building floors, building sections, or any other characterization appropriate for a given project.

For the exemplary screen shot 100 of a condominium complex, the object list 101 has, for example, either a pull-down listing or a scrollable tabular list and includes a building floor number 105 and a particular unit number 107 located on the selected floor. The object list 101 allows a large number of punch lists to be stored and quickly and readily located on an associated database (not shown). In one embodiment, the database may be located on the laptop or tablet PC. In another embodiment, the database is located on a remote centralized computer and accessed by the laptop or tablet PC through, for example, the Internet.

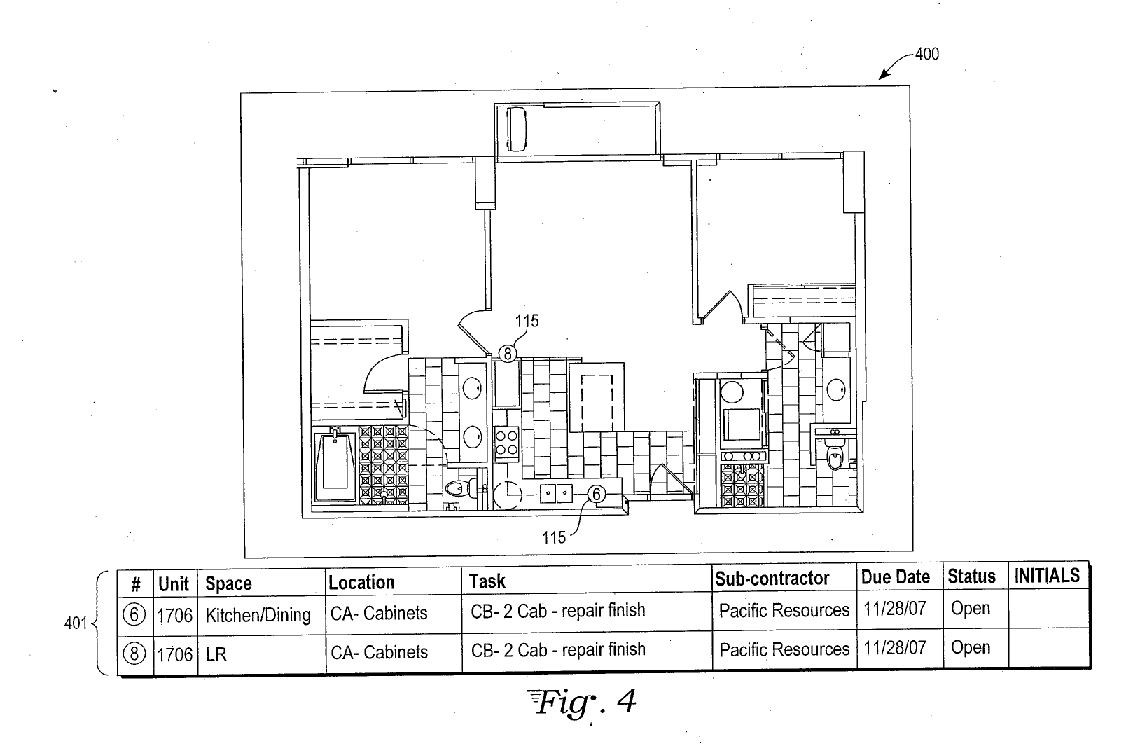

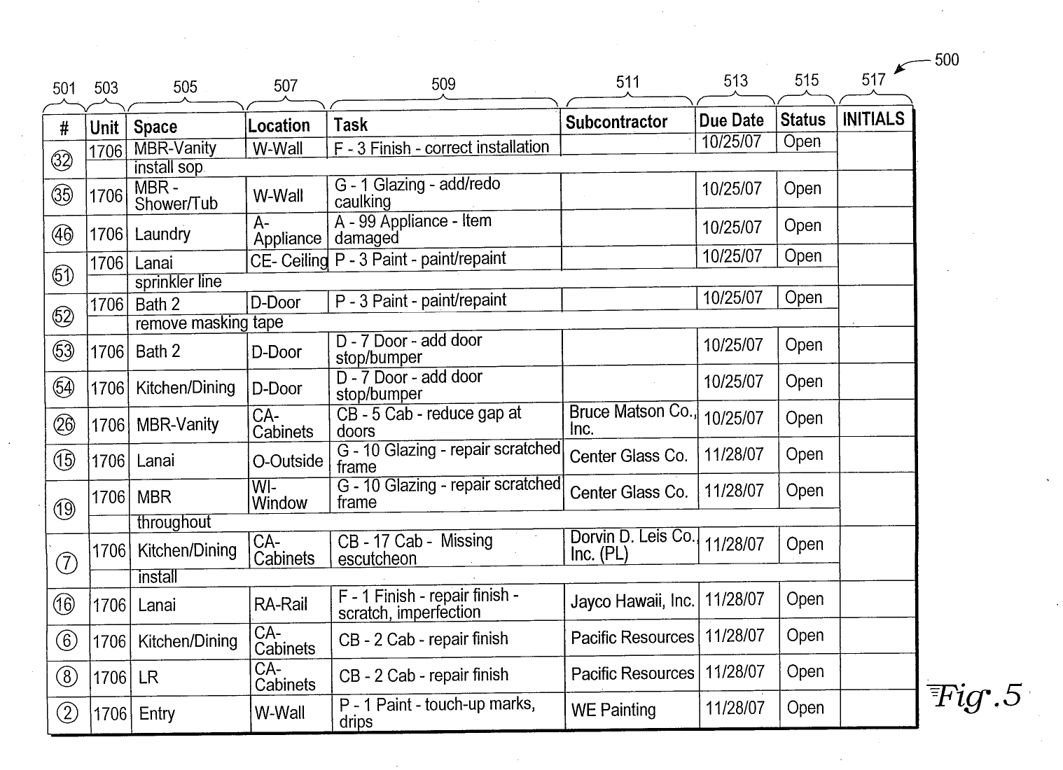

A plan view soft-button 109 and a list view soft-button 111 allow for a user to view either the floor plan, as shown, or a punch list view (not shown) in the graphical display area 103. A reports soft-button 113 allows a user to generate specific types of reports, explained in detail below with reference to FIGS. 4 and 5, below.

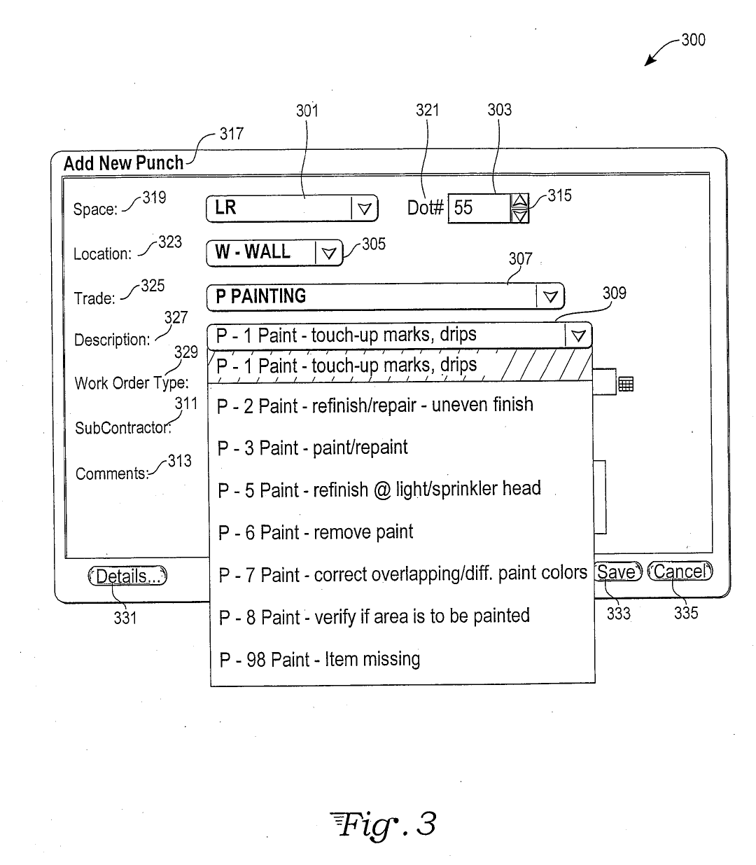

Each construction deficiency is indicated by a dot 115 and an associated dot number 117. Entry of data related to each dot 115 is discussed in detail below with reference to FIG. 3.

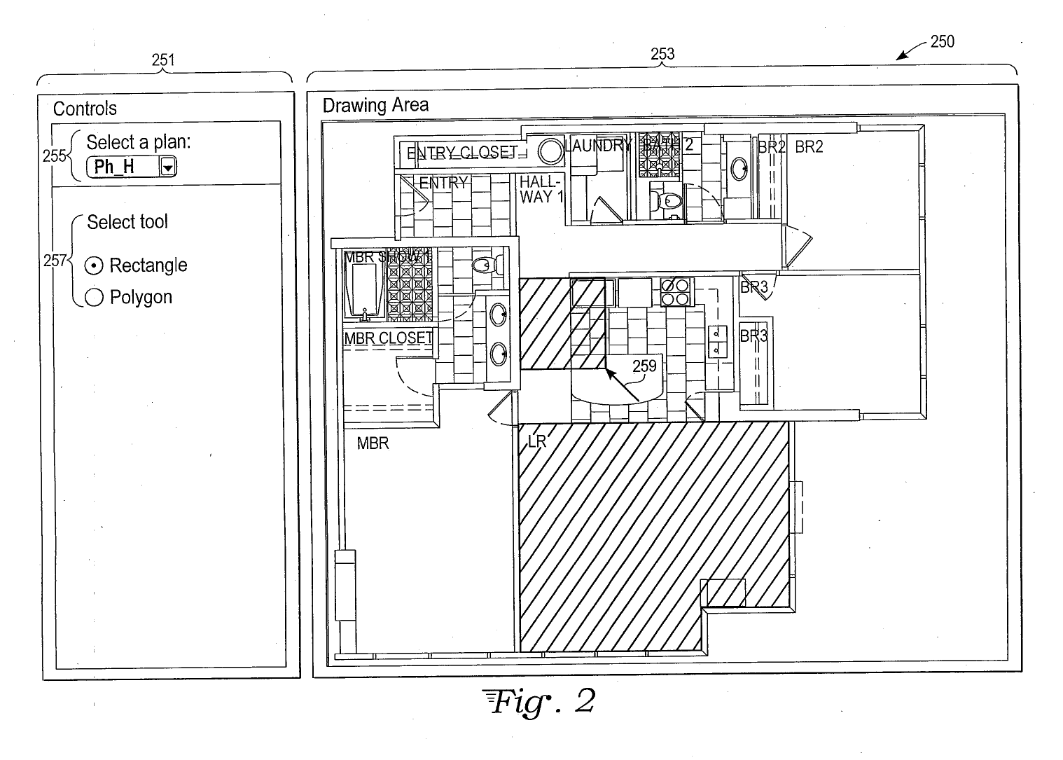

Referring now to FIG. 2, a layout definition screen shot 250 provides a simplified input screen for uploading graphics such as floor plans.

Once the one or more floor plans have been uploaded, a user may readily apply and define specific sections of each plan using tools in a control area 251. Effects from the use of the tools are seen directly in a drawing area 253. For example, a particular plan is selected via a plan selection soft-button 255. A selection tool 257 allows a user to select either a rectangle or polygon tool to drag and drop a defining area on the plan.

For example, FIG. 2 shows a rectangular selection tool applied to a kitchen area. A cursor 259 drags a corner until the rectangle fills the is kitchen area. In one embodiment, a dialog box opens for the user to enter a room name. In another embodiment, a separate title block (not shown) may be included in the control area 251. In still another embodiment, the uploaded floor plan already contains room name information. Implementation for each of these and related embodiments is known to a skilled artisan.

With reference now to FIG. 3, an exemplary pull-down entry screen 300 provides consistent entries from one inspector to another. A touch-screen sensitive device allows all inspectors to simply choose from a plurality of pull-down menus to enter all required data. Thus, data entry, and hence punch list development, is a simple and rapid process.

The pull-down entry screen 300 has a group of primary selection tools including a space soft-button 301, a dot number soft-button 303, a location soft-button 305, a trade soft-button 307, and a description soft-button 309. The user selects the space soft-button 301 for each room inspected such as the living room (“LR”). The dot number soft-button 305 is automatically incremented or decremented from a prior number value by simply selecting the “up” or “down” soft-keys 315 to the right. The inspector may purposely decrement the dot number soft-button 303 to go back and either verify or edit any prior entries.

The location soft-button 305 indicates precisely where a given construction deficiency exists. For example, a painting flaw may be located on the wall or ceiling. A missing electrical outlet may need to be added on the wall or the floor (e.g., a floor box for a lamp). The trade soft-button 307 allows a selection of which specific type of sub-contractor (e.g., plumbing, electrical, painting, etc.) is responsible to rectify the deficiency. The inspector may simply enter “General Contractor” if specifying a particular trade is ambiguous (e.g., whether caulking around a shower stall is performed by the plumbing or painting contractor since such decisions may vary in different geographical regions). As will be apparent to a skilled artisan, the trade soft-button 307 may alternatively display a list of sub-contractors if such sub-contractors are readily associated with a given trade. After the responsible trade is selected, a set of descriptors specific to that trade is available in the description soft-button 309. The inspector simply selects the appropriate descriptor from a pull-down menu to describe the deficiency.

In addition to the primary selection tools, an optional set of tools include, inter alfa, a sub-contractor soft-button 311 to select a sub-contractor by company name and a comments soft-button 313. Notes may be entered after selecting the comments soft-button 313 by, for example, a stylus if the inspector is using a tablet PC without a keyboard. However, since most descriptions necessary to correct a construction deficiency are available via the description soft-button 309, the comments soft-button 313 may be used infrequently except where specific directions or other information should be provided (e.g., an indication that a back charge will be made if the sub-contractor fails to correct a deficiency by a certain date).

Turning now to FIG. 4, an exemplary graphical floor plan report 400 for a finish carpenter indicates each dot 115 associated with a deficiency for only a specific trade. The exemplary graphical floor plan report 400 includes a text section 401 indicating details associated with each dot 115. Alternatively, reports showing deficiencies for all trades in a specific room (not shown) may be posted on the entry to each room of a floor plan. Additionally, a master report may be developed for the homeowner, owner's agent, general contractor, or architect detailing all deficiencies in a graphical form with complete detail for each deficiency.

In another exemplary embodiment, a tabular report 500 (FIG. 5) may be generated for each unit, floor, room, or trade. The tabular report 500 may include primary information such as a dot number reference 501, a unit or floor number reference 503, a room or area specific reference 505 with location information 507, and a task description column 509. The tabular report 500 may also include a sub-contractor column 511, a due date column 513, and a status column 515 indicating whether the deficiency item is still open or now closed. Prior to changing an “open” status to closed, the inspector must approve the change in an initial column 517. In one embodiment, the status column 515 may only be changed once the inspector “signs” the initial column 517 with an electronic signature (e.g., by entry of a code). In other embodiments, the status column 515 is changed simply by a drop-down menu (not shown).

The system and method for managing punch lists described herein provides a number of features and benefits that are likely now recognizable to a skilled artisan. For the sub-contractor, the features and benefits include ease-of-understanding of the punch list through consistent “pull-down” floor plans, descriptors, and graphical indications through the use of dots to show exactly where a problem is located. For the inspector, re-inspections are simplified through by using same process used to develop the punch list. Multiple inspectors can use the same punch list concurrently in different parts of the project. Owner's representatives, architects, and general contractors can view open punches thus eliminating duplicate efforts. Further, a master list containing all punch lists for a particular projects or series of projects may reside in one location and can be readily accessed by any number of construction personnel.

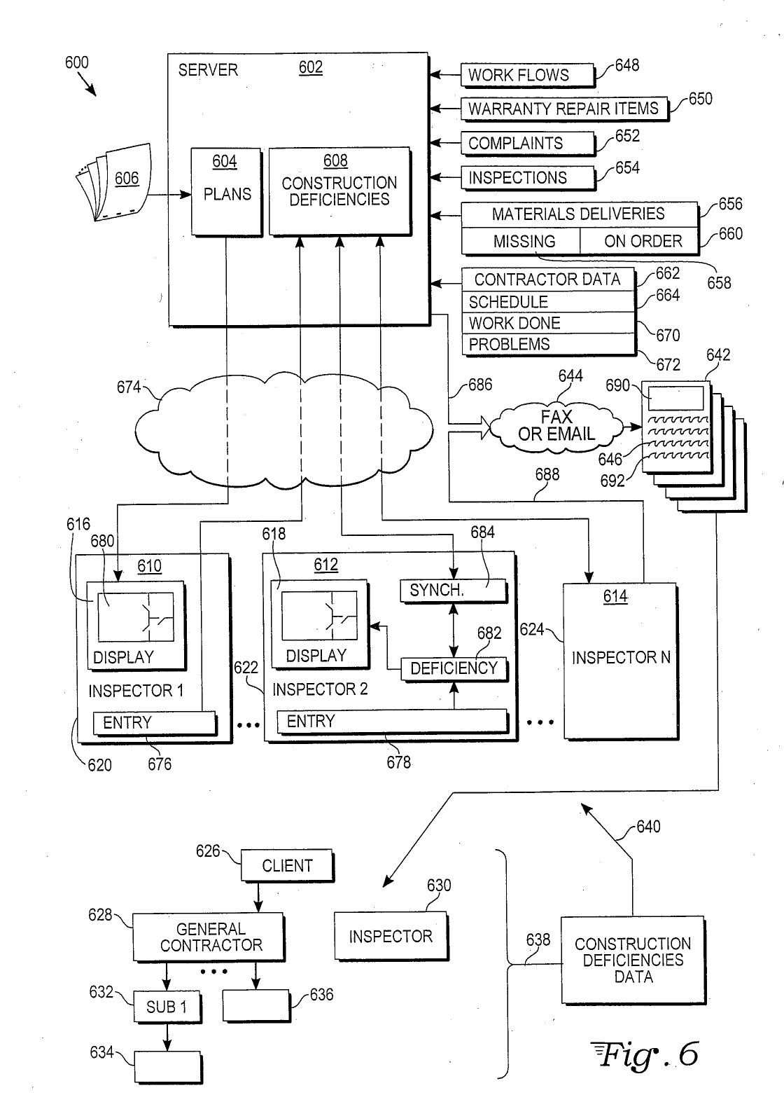

With reference to FIG. 6, an embodiment of a construction punch list system 600 has a server 602 containing a database 604 of contractor plans 606 for a construction project. The server 602 further contains construction deficiency data 608. The server 602 may be in communication with touchscreen 616 and 618 equipped display devices 610, 612 and 614, operating in on-line mode 620 or stand-alone mode 622 and 624. A client 626 or owner, along with a general contractor 628, one or more inspectors 630, sub-contractors 632, 634 and 636, an architect (not shown), members of a construction management firm (not shown) or other personnel may be noting 638 construction deficiencies. As these construction deficiencies are reported 640 through the system 600, construction deficiency data 608 is updated. Upon request, a construction punch list 642 may be sent through fax or e-mail 644. A construction punch list 642 may be used by personnel to guide work to correct a construction deficiency. This process may be iterated until construction punch list entries 646 are cleared.

Additional information may be input to and reside on the server 602, such as workflows 648, warranty repair items 650, complaints 652, inspection checklists 654, materials delivery checklists 656, materials missing 658, materials on order 660, contractor data 662, schedules 664, work done 670, problems 672 and so on. Data may reside in a single database, separate databases, combined data, data associated with databases, mixed data, distributed data and other forms known in the art.

At the construction site, during construction or inspection, punch items for construction deficiencies may be entered by one or more initiating parties. Initiating parties are typically the general contractor, architect and owner via a construction management firm.

A display device with an interactive touchscreen affords portability and mobility. As shown in FIG. 6, a display device 610 may have a connection to the server, such as an Internet connection 674, a wireless network connection (not shown), a wired connection (not shown), a virtual private network connection (not shown) or other connection known in the art. Each display device 610 and 612 has a display 616 and 618, which may be a touch screen. Each display device 610 and 612 has an entry device 676 and 678, which may be a portion of the touchscreen, a keyboard, a touch pad, a mouse or other entry device known in the art.

A display device 610 operating in on-line mode 620 may be used for entering construction deficiency data 608 directly to the server 602, using the entry device 676 and via the connection 674 to the server. In on-line mode 620, the display device 610 displays a selected plan 680 from the database 604, residing on the server 602, of contractor plans 606 for the construction project.

A display device 612 operating in stand-alone mode 622 may have, in addition to the display 618 and the entry device 678, a local version 682 of the construction deficiency data 608 and an update device 684. Alternatively, the update device 684 may be present in the server. The entry device 678 may be used for entering construction deficiency data to the local version 682 of the construction deficiency data 608. When the display device 612 is connected to the server 602, such as by an Internet connection 674, a wireless network connection, a wired connection or other connection known in the art, the update device 684 updates the construction deficiency data 608 at the server 602 and the local version 682 of the construction deficiency data by using data comparison.

Updating by data comparison involves a connection 674 between a server 602 and a display device 612 with a local version 682. By contrast, updating by manual entry involves entering data directly to a server database to update the database, or entering data directly to a local version 682 of data, to update that local version 682.

In one embodiment, updating by using data comparison is performed by following a synchronization procedure. An inspector has a portable display device intended for operation in stand-alone mode at a construction site. The inspector synchronizes the local version of the construction deficiency data in the display device to the construction deficiency data at the server, before leaving an office where there is an Internet connection. Which record is the most recent is determined by comparing data on a record by record basis. Newer field unit records are uploaded and newer server records are downloaded. Upon completion of the synchronizing, both the server and the display device have the most recent records in the database. After inspection and the field, the inspector returns to a location with Internet access and synchronizes again. The server maintains revision dates and the master version of the records.

Upon request, the server may generate or produce 686 a construction punch list 642, based upon construction deficiency data associated with a construction plan. Further, a display device may produce 688 the construction punch list 642. Still further, the server and a display device may cooperatively produce 686 and 688 a construction punch list 642. The construction punch list may be in graphical form 690, tabular form 692, or a combination 690 and 692 of graphical and tabular forms. The construction punch list 642 may be printed or sent by fax or e-mail 644 or other connection or communication means.

In an embodiment, FinishLine software operates, in the field, for inspection, on any touch screen tablet PC running Windows XP tablet or Vista Business or Ultimate and a standard browser. In a further embodiment, the system works for reporting or off-site data entry on any PC or Mac running standard browser software.

In an embodiment, a construction plan is input as a .PDF file and converted to a Flash .swf file. FinishLine software is used for viewing the files. FinishLine software is programmed in Flex, an interactive programming environment that may produce a Flash movie or an interactive multi-media environment. The Flash movie or interactive multi-media environment is viewable on a browser.

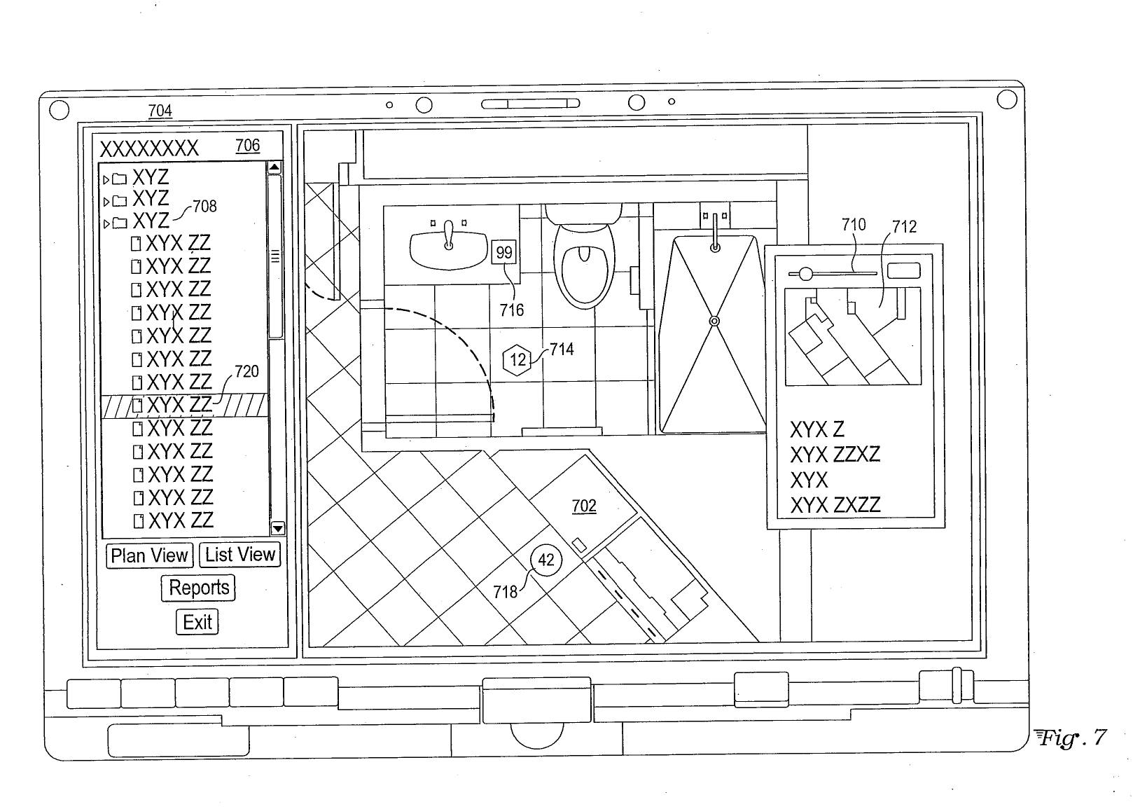

With reference to FIG. 7, a construction plan 702 is shown as displayed on a touchscreen device 704. The construction plan 702 is displayed in a graphical representation of a contractor plan for a construction project from a database of contractor plans. From the object list 706, a building floor number 708 or a particular unit number 720 is selected, as similarly and previously described with reference to FIG. 1. Zoom 710 and pan control 712 allow selecting an area within a floor or room displayed, for viewing in greater detail. Zooming provides a magnified view. Panning provides moving the magnified, displayed area to view a new area or region in an area. Construction deficiency symbols 714, 716 and 718, each numbered and of various shapes or colors, are shown placed on the construction plan as displayed.

In an embodiment, each construction deficiency symbol has an appearance unique to a category of punch items. For example, a construction deficiency symbol may have a different color for each trade type or sub-contractor. A construction deficiency symbol may have a different shape for each trade type or sub-contractor. A construction deficiency symbol may have a dot number. In this manner, the construction deficiency symbols are shape-coded or color-coded or numbered, or a combination thereof.

With reference back to FIG. 3, a pulldown menu, entitled add new punch 317, allows entering construction deficiency data. Space 319, dot #321, due date (not shown, underneath the description drop-down list), location 323, trade 325, description 327, work order type 329, sub-contractor 311, comments 313 or other data may be added to describe a construction deficiency as marked by a construction deficiency symbol. Details may be requested by clicking on the details soft-button 331. The new construction deficiency data may be saved by clicking the save soft-button 333 or the save & exit soft-button (not shown, proximate to the save soft-button). Data entry may be canceled by clicking the cancel soft-button 335. The construction deficiency data may be deleted by clicking the delete soft-button (not shown, proximate to the save soft-button). Clicking on the complete soft-button (not shown, proximate to the save soft-button) completes the task, marks the task as complete in the construction deficiency data and any construction punch list referencing that completed task, and removes the construction deficiency symbol.

Clearing, approving or completing a punch list item are equivalent actions. Completing an item changes the status of the item from open to complete, while information about the item remains in the database. In contrast, deleting the item removes data about the item from the database, for example if the data about the item had been put into the database in error.

When the status of an item is open, the item is still shown on the plan view. Status is user definable, and the user may define what status indicates an item is no longer open. Example open states include on order, pending approval, or states other than defined as not open.

In an embodiment, each of the general contractor, architect or developer logs into the system as a different inspection party. Punches created by each party are in a different color or shape. An inspection lo group may not alter or delete items originating from another group.

With reference back to FIG. 4 and FIG. 5, a construction punch list may be generated, showing construction deficiency data in graphical 400 or tabular 500 form. Although FIG. 4 shows construction deficiency data in graphical 400 and tabular 401 form, in an embodiment is construction deficiency data may be presented on a construction punch list solely in graphical form, solely in tabular form 500 or in combined graphical and tabular form. A report, having a construction punch list, may be printed, faxed or e-mailed for distribution, or transferred as a file. The construction punch list may list all punch items, or may be specific to a sub-contractor, a trade, a room, a floor or another category of punch items.

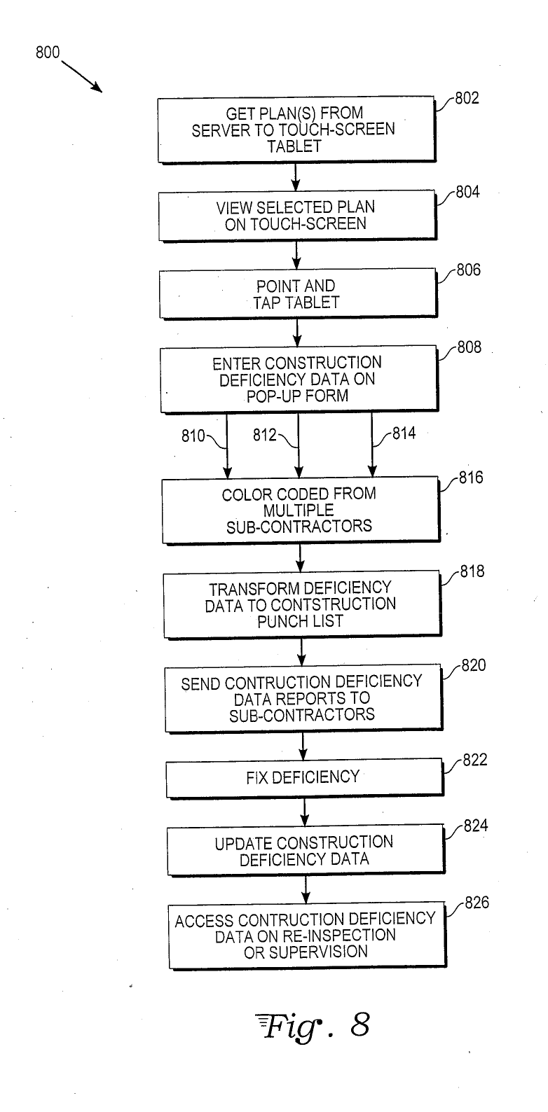

With reference to FIG. 8, a flow diagram shows establishing and using a construction punch list system 800. For each touchscreen tablet making use of the system, get plans from the server to the touchscreen tablet 802. Getting plans from the server to the touchscreen tablet may involve formatting the construction plans and sending them over the Internet for viewing on a display device, in on-line mode. Getting plans from the server to the touchscreen tablet may involve connecting to the server and making a local version of the construction plans for use on the touchscreen tablet in stand-alone mode.

Viewing a selected plan on the touchscreen 804 may involve selecting a plan and displaying the selected plan on a display device, for viewing. Selecting and displaying may take place using a plan from the server in on-line mode or using a plan from the server as a local version in stand-alone mode.

Point and tap tablet 806 to select a position for a construction deficiency symbol. The symbol is placed at the location pointed to, relative to the construction plan being displayed, and carries the attributes entered. The construction deficiency symbol indicates a construction deficiency at a corresponding location on the construction site.

Enter construction deficiency data on a form 808 in order to describe the construction deficiency observed at the location indicated by the construction deficiency symbol. A pop up form, a drop-down menu or other form may be used. Entering along with other construction deficiency data a specific sub-contractor assigns a color or shape coding to the construction deficiency symbol. In this manner, the sub-contractor responsible for fixing the construction deficiency is identified by a color or shape coding of the construction deficiency symbol. The construction deficiency symbol may have a color or shape specific to a category of construction deficiency other than the trade or sub-contractor responsible for remedying the construction deficiency. Multiple arrows 810, 812 and 814 on the flow diagram denote construction deficiency data and color codings associated with multiple-sub-contractors 816, which may be entered by multiple personnel using multiple display devices or by a single inspector identifying multiple sub-contractors.

Transform construction deficiency data to a construction punch list 818. As previously discussed, with reference to FIG. 4 and FIG. 5, may be prepared in graphical form, tabular form or a combination of graphical form and tabular form. A punch list may be prepared as part of a report for a specific trade, for a specific room, for an entire floor, for a portion of the deficiencies or the entirety of the deficiencies and other combinations and subsets. Transforming construction deficiency data to a construction punch list may involve sorting, formatting, rearranging, forming a subset or other operations known in the art.

Send construction deficiency data reports to sub-contractors 820. The sending may be in printed form or in electronic form, as by e-mail, file transfer or fax.

Fix deficiencies 822. Using a construction punch list as a guide, the sub-contractor responsible for a punch list item fixes or otherwise remedies the deficiency by making the appropriate repair, installation, change or otherwise performing the indicated task.

Update construction deficiency data 824. Construction deficiency data is updated by manual entry, to indicate remedy of a deficiency or clearing of a punch list item upon an inspection. Construction deficiency data is updated by data comparison, to reconcile construction deficiency data at the server with any local version or copy of construction deficiency data.

Access construction deficiency data on re-inspection or supervision 826. An inspector or supervisor may need to view, update or otherwise access construction deficiency data in order to add, modify or clear information about a construction deficiency.

The process may be iterated until all construction deficiencies are cleared.

The present invention is described above with reference to specific embodiments thereof. It will, however, be evident to a skilled artisan that various modifications and changes can be made thereto without departing from the broader spirit and scope of the present invention as set forth in the appended claims. For example, although described herein with reference to printed punch lists, the punch lists may be sent electronically to each sub-contractor via e-mail. Alternatively, a sub-contractor may log-in to view construction status of the project and when approvals were received. Further, an inspector can either e-mail or upload (e.g., via the Internet or through a connection to a virtual private network) all completed punch lists to the office to be printed in advance of the inspector's arrival. These and various other embodiments are all within a scope of the present invention. The specification and drawings are, accordingly, to be regarded in an illustrative rather than a restrictive sense.

What is claimed is:

1. A portable touchscreen computer device for graphically displaying construction defects in connection with floor plans comprising:
a viewer window, the viewer window having a touchscreen and capable of displaying a selected floor plan and a selective text display; and
touch means for construction deficiency text entry by touching the selective text display displayed in the viewer window on the touchscreen and for construction deficiency symbol entry on a selected location of the selected floor plan displayed in the viewer window by touching the selected location of the selected floor plan on the touchscreen.

2. The portable touchscreen computer device of claim 1 further comprising means for electronically communicating with a server.

3. The portable touchscreen computer device of claim 2 wherein the viewer window is capable of displaying an object list.

4. The portable touchscreen computer device of claim 3 wherein the server stores a set of electronic floor plans for a construction project/view, each plan identified in the object list from which a floor plan is selected.

5. The portable touchscreen computer device of claim 4 wherein the portable touchscreen computer device has drop down menus for construction deficiency text entry and is adapted for construction deficiency text entry by touching said menus.

6. The portable touchscreen computer device of claim 4 wherein the construction deficiency symbol appears in the selective text display.

7. A touchscreen system for graphically displaying construction defects in connection with floor plans comprising:
a central server storing a set of electronic floor plans for a construction project; and
a plurality of portable touchscreen computer devices synchronizable with the central server, each portable touchscreen device having a viewer window, the viewer window having a touchscreen and capable of displaying a selected floor plan and a selective text display, each portable touchscreen computer device having touch means for construction deficiency text entry by touching the selective text display on the touchscreen and for construction deficiency symbol entry on a selected location of the selected floor plan by touching the selected location on the touchscreen, with the construction deficiency symbol appearing in both the selective text display and the selected floor plan.

8. The touchscreen system of claim 7 wherein each of the portable touchscreen computer devices includes an update device.

9. The touchscreen system of claim 7 wherein the viewer window displays an object list identifying each plan and from which a floor plan is selected.

10. A touchscreen system for graphically displaying construction defects in connection with floor plans comprising:
a central server storing a set of electronic floor plans for a construction project, each plan identified in an object list from which a floor plan is selected;
a plurality of portable touchscreen computer devices in selective electronic communication with the server, each portable touchscreen device having a viewer window, the viewer window capable of displaying the object list, a selected floor plan, and a construction deficiency list, the portable touchscreen computer device having touch means for floor plan selection, text entry and construction deficiency symbol entry and having a selective text display capability for entering text in the viewer window, with construction deficiency symbol entry appearing in both the text display and on the selected floor plan, the construction deficiency symbols designating construction defects or conditions that are associated with text in the text display.

11. The apparatus of claim 10 wherein each portable touchscreen computer device is adapted for symbol entry on the selected floor plan by touching the portable touchscreen computer device on a selected location of the selected floor plan.

12. The apparatus of claim 10 wherein the construction deficiency list of each portable touchscreen computer device has drop down menus for text entry and is adapted for text entry on the selected floor plan by touching said menus on the portable touchscreen computer device.

13. The apparatus of claim 10 wherein from the object list a report view is selectable.

14. The apparatus of claim 10 wherein the construction deficiency symbols have different colors specific to different construction deficiencies.

15. The apparatus of claim 10 wherein the construction deficiency symbols have different shapes specific to different construction deficiencies.

16. The apparatus of claim 10 wherein the construction deficiency symbols are specific to construction deficiencies with text associated with each symbol explanatory of the symbol.

17. The apparatus of claim 10 wherein the number of portable touchscreen devices in the plurality of portable touchscreen computer devices is at least equal to a number of sub-contractors for the construction project.

18. The apparatus of claim 10 further comprising a soft button in the construction deficiency list for selecting specific sub-contractors.

19. The apparatus of claim 10 further comprising a soft button in the construction deficiency list for associating a construction deficiency symbol with text related to the construction deficiency symbol.

20. The apparatus of claim 10 further comprising means for editing construction deficiency symbols and text to remove said construction deficiency symbols and text.
